(19) United States
(12) Patent Application Publication
(10) Pub. No.: US 2020/0342788 A1
(43) Pub. Date: Oct. 29, 2020

(54) FINGER-PROOF LABELS FOR PACKAGES

(71) Applicant: Bemis Company, Inc., Neenah, WI (US)

(72) Inventor: Reinaldo V. CALEMAN, JR., Neenah, WI (US)

(21) Appl. No.: 16/958,116

(22) PCT Filed: Dec. 27, 2017
(86) PCT No.: PCT/US17/68487

§ 371 Date: Jun. 25, 2020

(51) Int. Cl. G09F 3/00; G09F 3/10; G09F 3/03; B65D 75/58

(52) U.S. Cl. CPC G09F 3/0289; G09F 3/10; G09F 2003/0222; B65D 75/5855; G09F 3/0341

(57) ABSTRACT

A package label is described. The package label comprises a first ply, a second ply, and a first edge. The second ply comprises a pull tab comprising a first boundary adjacent the first edge, a second boundary opposing the first boundary, and an adhesive deadener area. The second ply also comprises a frangible area adjacent the second boundary and positioned apart from the adhesive deadener area. The frangible area comprises multiple lines of weakness forming a discontinuous series of shapes. Various embodiments of the package label area also described.

The present application relates generally to labels for packaging for various products. More particularly, the present application relates to finger-proof labels for packages for food and non-food products.

### BACKGROUND

The use of labels for accessing or repeatedly accessing the contents of a package are known. For example, U.S. Pat. No. 4,679,693 (Forman) discloses a resealable container with a tearable face that is opened and resealed by a label. The label includes multiple layers and, for tamper evidence, requires that an end-user remove a layer covering or overlaying a pull tab in order to operationally access the label to open the package.

Other forms of tamper-evidence have been integrated into packaging films. For example, U.S. Pat. No. 7,681,732 (Moehlenbrock et al.) discloses a laminated lidstock comprising a substrate film, a support film, a pressure sensitive adhesive disposed between the substrate film and the support film, a first die cut in the substrate film, a second die cut in the support film, a pull tab, and a tamper evidence device. To open the package, an end-user must remove the tamper evidence device (i.e., a first end portion of the support film) from the substrate film in order to access the pull tab which the end-user may then use to peel back the support film. The tamper evidence is indicated when printed indicia is revealed upon removal of the end portion of the support film from the substrate film. The package requires printing indicia in registration on the surface of the substrate film.

As another example, US Publication 2015/0117797 (Cigallio et al.) discloses tamper-indicating elements for flexible, reclosable packages. Such tamper-indicating elements include one or more self-terminating shapes with an open or closed geometry that forms one or more chads after initial opening of the package. The chads transfer from one film to another film. The self-terminating shapes indicate whether or not the package has been opened or otherwise accessed.

As a yet further example, US Publication 2016/0221740 (Tinoco) discloses a tamper evident feature comprising a spiral part included on a peel reclose label. Upon peeling the label, the spiral part unravels. Upon reclosing the label, the spiral part is difficult to align to its original location.

### SUMMARY

What is needed is an opening feature that does not simply indicate access or tampering but that actually prevents access or tamper by a finger, pen, needle, or other object slid or otherwise inserted underneath a pull tab.

Embodiments of the present application include finger-proof labels and peelable/resealable finger-proof labels. Such labels may be sealed to packages comprising a package body such as, as a non-limiting example, a tray having a top portion, a bottom portion, and side portions connecting the bottom portion to the top portion. In such embodiments, the finger-proof label may be sealed to the top portion (such as, as a non-limiting example of a top portion, a perimeter flange) of the package body. In other embodiments, the finger-proof label may be combined with other various packaging configurations, including but not limited to bags, pouches, stand-up pouches, quad pouches, over-wraps, lidding film, rigid or semi-rigid thermoformed trays, vacuum packages, vacuum skin packaging, or the like. In the various embodiments, the finger-proof label comprises an unsealed pull tab and a finger-proof feature to prevent access to or tamper with the package contents prior to an end-user desiring to access the contents.

According to one embodiment, the finger-proof label includes a frangible area proximate or otherwise adjacent the unsealed pull tab. The frangible area comprises multiple lines of weakness forming a discontinuous series of shapes. This frangible area prevents a finger or other object from being slid or other inserted underneath the pull tab in an attempt to access or tamper with the package contents, as the frangible area tears when an object is inserted underneath the pull tab.

The finger-proof label may include a monolayer film or a multilayer film, depending upon the requirements of a particular packaging application. Film layers may include but are not limited to oxygen barrier layers, moisture barrier layers, chemical barrier layers, abuse layers, tie or adhesive layers, bulk layers, odor scavenging layers, or oxygen scavenging layers. It is contemplated that the packages or package bodies may be formed from many different materials such as, as non-limiting examples, thermoplastics, papers, non-woven materials, metal foils, or combinations of such. In some embodiments, the packages may include oxygen barrier film and may have an oxygen transmission rate (O₂TR) value of less than or equal to 10 cm³/100 in²/24 hours at 1 atmosphere, 23° C., and 0% relative humidity.

The finger-proof label may be formed from any thermoplastic material including but not limited to polyolefin polymers such as polyethylene, ethylene copolymers, or polypropylene; polyamide; polyethylene terephthalates; or combinations of such. In some embodiments, the label may include an oxygen barrier material or a moisture barrier material. The label may use an exposed area of pressure sensitive adhesive or other removable adhesive to peelably reseal the label to a package body. In some embodiments, the label may comprise a pattern-applied coating of pressure sensitive adhesive; in other embodiments, the label may comprise a coextensive layer of pressure sensitive adhesive. In some embodiments, the label may comprise a layer of pressure sensitive adhesive and an oxygen barrier layer. In some embodiments, the label may comprise a layer of pressure sensitive adhesive and an abuse layer. In some embodiments, the label may comprise a pressure sensitive adhesive layer and any number of additional layers depending upon the requirements of a particular packaging application.

Specifically, in a first set of embodiments, this package label has a first ply, a second ply, and a first edge. The second ply has a pull tab that has a first boundary adjacent the first edge of the package label, a second boundary opposing the first boundary, and an adhesive deadener area. In some embodiments of the first set of embodiments, the first boundary of the pull tab is positioned at an approximate center of the first edge.

In the first set of embodiments, the second ply also has a frangible area adjacent the second boundary and positioned apart from the adhesive deadener area. The frangible area comprises multiple lines of weakness forming a discontinuous series of shapes. In some embodiments of the first set of embodiments, the discontinuous series of shapes is formed in the absence of a linear first line of weakness that connects the discontinuous series of shapes from a first end of the frangible area to a second end of the frangible area. In some embodiments of the first set of embodiments, the discontinuous series of shapes is a series of linear shapes. In some of these embodiments, a first half of the linear shapes forms a 30° angle with the second boundary of the pull tab and a second half of the linear shapes forms a 150° angle with the second boundary. In some embodiments of the first set of embodiments, the discontinuous series of shapes is a series of non-linear shapes. In some embodiments of the first set of embodiments, each of the shapes within the discontinuous series of shapes has an open geometry shape. In some embodiments of the first set of embodiments, the discontinuous series of shapes is a combination of linear shapes and non-linear shapes.

In some embodiments of the first set of embodiments, the package label is adapted to prevent an object from being inserted underneath the pull tab to access contents of a package body. In some embodiments of the first set of embodiments, the package label is adapted to tear at the frangible area when an object is inserted underneath the pull tab.

In some embodiments of the first set of embodiments, the first ply has a second line of weakness. In some embodiments of the first set of embodiments, the first ply has a sealant layer adapted to seal the package label to a package body.

In some embodiments of the first set of embodiments, each of the first ply and the second ply has multiple layers. In some of these embodiments, the second ply has a removable adhesive layer adapted to peelably reseal the package label to a package body.

In some embodiments of the first set of embodiments, a package includes the package label and the package label is sealed to a package body. In some of these embodiments, the package body is a tray.

### BRIEF DESCRIPTION OF THE DRAWINGS

FIG. 1 is a schematic view of a first embodiment of a finger-proof package label according to the present application.

FIG. 2 is a schematic view of various non-limiting example embodiments of the discontinuous series of shapes formed by the multiples lines of weakness according to the present application.

FIG. 3 is a schematic cross-sectional view of the label of FIG. 1, taken along line 3-3.

FIG. 4 is a partial perspective view of a package with an embodiment of a finger-proof package label according to the present application.

### DETAILED DESCRIPTION

An embodiment of a finger-proof package label is formed with a frangible area proximate or otherwise adjacent an unsealed pull tab. The frangible area comprises multiples lines of weakness forming a discontinuous series of shapes.

As used throughout this application, the term “frangible” refers to the ability to be broken into fragments, torn, or divided; the characteristic of being brittle or fragile or breakable; or the like.

As used throughout this application and as shown in the various figures, the terms “proximate, “adjacent,” or “otherwise adjacent” refer to being near, close, contiguous, adjoining, or neighboring in proximity. Such terms include but are not limited to being reasonably close to or in the vicinity of as well as touching, having a common boundary, or having direct contact.

As used throughout this application, the term “discontinuous” refers to an element comprising separated, spaced apart, or otherwise unconnected segments. As used throughout this application, the term “continuous” refers to an element comprising connected segments throughout the element, with no gaps present between the segments.

In some embodiments, the frangible area with the multiple lines of weakness may be parallel to a side or boundary of the unsealed pull tab. In other embodiments, the frangible area may simply be adjacent a boundary of the unsealed pull tab. The series of shapes within the frangible area extends from a first end of the frangible area to a second end of the frangible area. In some embodiments, no separate linear line of weakness (whether continuous or discontinuous) connects the discontinuous series of shapes from the first end to the second end.

The frangible area comprises multiple lines of weakness. Such lines of weakness may extend partially or completely through the entire thickness of the package label. As known to a person of ordinary skill in the packaging or label arts, in the various embodiments, the multiple lines of weakness may comprise a continuous or discontinuous series of scores, holes, vents, slits, slots, perforations, notches, punctures, orifices, openings, inlets, channels, etc., in the surface of or through a layer or layers or the package label or may comprise a zone of an easy-tear material, such as an easy-tear sealant film. Lines of weakness may be formed by die-cut, laser, or other means known to a person of ordinary skill in the packaging or label arts.

The multiple lines of weakness form a discontinuous series of various shapes. Non-limiting examples of such shapes include linear shapes (i.e., line segments), non-linear shapes, or combinations of such. As used throughout this application, the term “linear” refers to a shape or geometry that is, of, relating to, denoting, or involving a straight line substantially throughout, traced by a point traversing in a constant direction and having an equation that may be written in slope-intercept form y=mx+b, where “m” is the slope and “b” is the y-intercept. The term “non-linear” is in contrast to the terms “linear.” As used throughout this application, the term “non-linear” refers to a shape or geometry that is not a straight line substantially throughout, such that it has at least two dimensions and is traced by a point traversing in at least two directions. Non-limiting examples of non-linear shape include curved, curvilinear, arcuate, square, circle, v-shaped, inverted v-shaped, s-shaped, z-shaped, w-shaped, inverted w-shaped, m-shaped, c-shaped, reverse c-shaped, u-shaped, n-shaped, or bean-shaped.

The frangible area prevents a person from placing a finger or other object underneath the pull tab and accessing or tampering with the package contents. If someone attempts to introduce a finger or another object underneath the pull tab, the tab will be forced upward and the frangible area will tear, causing the finger or other object to slide over the exterior (i.e., the outermost surface) of the package label instead of into the package. As such, in various embodiments, the package label is adapted to prevent an object from being inserted underneath the pull tab to access contents of a package body. In various embodiments, the package label is adapted to tear at the frangible area when an object is inserted underneath the pull tab.

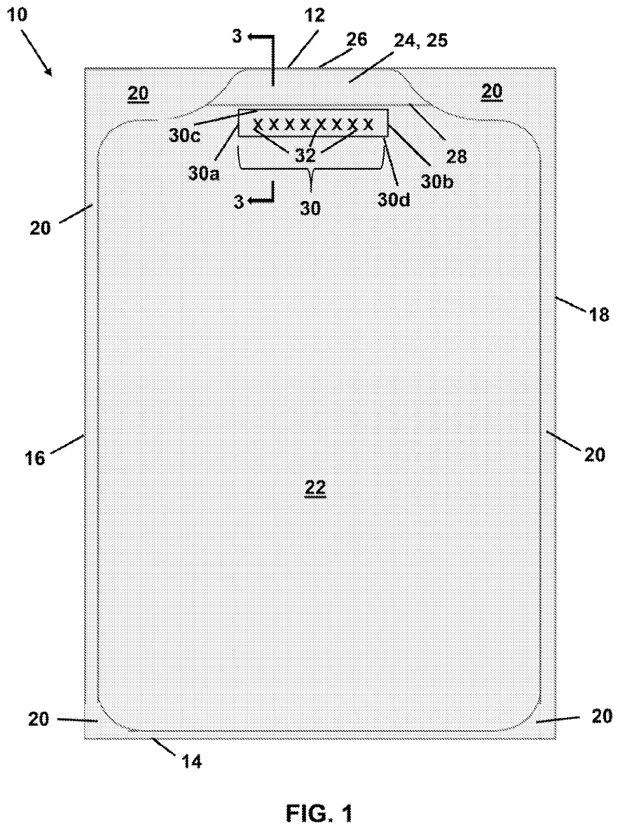

Referring to the drawings, with some but not all embodiments depicted, with elements depicted as illustrative and not necessarily to scale, and with the same (or similar) reference numbers denoting the same (or similar) features throughout the drawings, FIG. 1 is a schematic view of a first embodiment of a finger-proof package label according to the present application. Package label 10 comprises first edge 12, second edge 14 opposing first edge 12, third edge 16 substantially perpendicular to first edge 12 and second edge 14, and fourth edge 18 opposing third edge 16. Package label 10 further comprises first ply 20 and second ply 22. Each of first ply 20 and second ply 22 may comprise a monolayer film or a multilayer film. In other words, each of first ply 20 and second ply 22 may comprise one layer or multiple layers.

Second ply 22 comprises pull tab 24. Pull tab 24 comprises first boundary 26, second boundary 28 opposing first boundary 26, and, as pull tab 24 is unsealed (completely or partially), adhesive deadener area 25 facilitating grasping of pull tab 24. Adhesive deadener area 25 may be positioned at any location on or throughout the interior surface (i.e., the innermost surface) of pull tab 24. In the embodiment of FIG. 1, adhesive deadener area 25 is positioned throughout the interior surface of pull tab 24.

First boundary 26 of pull tab 24 is adjacent first edge 12. In some embodiments, such as that depicted in FIG. 1, first boundary 26 may be directly adjacent (i.e., in direct contact) with first edge 12. In other embodiments, the first boundary may be spaced apart from but still adjacent (i.e., in the proximity of, near, close, or neighboring in proximity to) the first edge.

In some embodiments, such as that depicted in FIG. 1, first boundary 26 of pull tab 24 is positioned at an approximate center of first edge 12. In other embodiments, the first boundary and the pull tab are not limited to a centered position and may be positioned at any location adjacent the first edge.

Second ply 22 also comprises frangible area 30. In some embodiments, such as that depicted in FIG. 1, frangible area 30 is adjacent second boundary 28, specifically, parallel to each of first boundary 26 and second boundary 28. In other embodiments, such as those where the first boundary is non-linear and the second boundary is linear, the frangible area may be adjacent the second boundary and parallel to the second boundary but not the first boundary. In yet other embodiments where each of the first boundary and the second boundary is non-linear, the frangible area may be adjacent the second boundary but not parallel to either the first boundary or the second boundary. Frangible area 30 is positioned apart from, i.e., separated from and not in the region of, pull tab 24, specifically (in the embodiment depicted in FIG. 1) adhesive deadener area 25 of pull tab 24.

Frangible area 30 comprises first end 30a, second end 30b opposing first end 30a, first side 30c substantially perpendicular to first end 30a and second end 30b, and second side 30d opposing first side 30c. Frangible area 30 also comprises multiple lines of weakness forming discontinuous series of shapes 32. In the embodiment depicted in FIG. 1, discontinuous series of shapes 32 comprises x-shapes. In some embodiments, as in the embodiment depicted in FIG. 1, no linear line of weakness is present that connects the discontinuous series of shapes, e.g., no linear “first” line of weakness (whether continuous or discontinuous) connects the x-shapes within discontinuous series of shapes 32 from first end 30a to second end 30b. In this embodiment, the x-shapes are discontinuous and unconnected within frangible area 30.

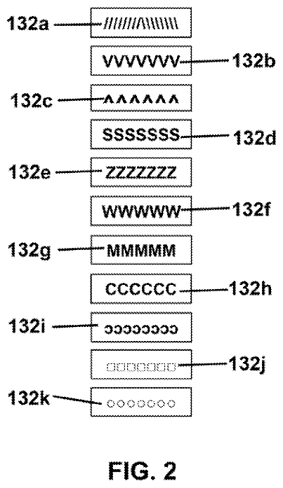

As described above, the discontinuous series of various shapes may include linear shapes (i.e., fine segments), non-linear shapes, or combinations of such. FIG. 2 is a schematic view of various non-limiting example embodiments of the discontinuous series of shapes formed by the multiple lines of weakness within the frangible area according to the present application. Discontinuous series of shapes 132a represents a series of linear shapes, i.e., a series of line segments. In various embodiments, such line segments (while not directly adjacent to) may form various angles with the second boundary of the pull tab. As non-limiting examples, such line segments may be generally perpendicular to the second boundary (i.e., may form a 90° angle with the second boundary), may form a 30° angle with the second boundary, may form a 0° angle with the second boundary, may form a 120° angle with the second boundary, or may form a 150° angle with the second boundary. In other embodiments, a first half of the linear shapes (i.e., line segments) in the discontinuous series may form one angle (such as, as a non-limiting example, a 30° angle) with the second boundary and a second half of the linear shapes (i.e., line segments) may form another angle (such as, as a non-limiting example, a 150° angle) with the second boundary. In various embodiments, the line segments may have various lengths, such as, as non-limiting examples, from 0.5 mm to 10 mm, from 1 mm to 5 mm, from 2 mm to 4 mm, 3 mm, etc.

Other non-limiting example embodiments of the discontinuous series of shapes depicted in FIG. 2 include V-shaped (discontinuous series of shapes 132b), inverted v-shaped (discontinuous series of shapes 132c), S-shaped (discontinuous series of shapes 132d). Z-shaped (discontinuous series of shapes 132e), W-shaped (discontinuous series of shapes 132f), M-shaped (discontinuous series of shapes 132g), C-shaped (discontinuous series of shapes 132h), and reverse c-shaped (discontinuous series of shapes 132j). These examples represent series of non-linear shapes.

These examples, as well as the line segments of discontinuous series of shapes 132a, represent shapes having an open geometry shape. Examples of shapes having a closed geometry shape include but are not limited to square (discontinuous series of shapes 132j) and circle (discontinuous series of shapes 132k). In various embodiments, each of the shapes within the discontinuous series of shapes has an open geometry shape. This may reduce the risk of contamination from chads. With a closed geometry shape, chads may form when the package label is peeled from a package body or when the frangible area is tom.

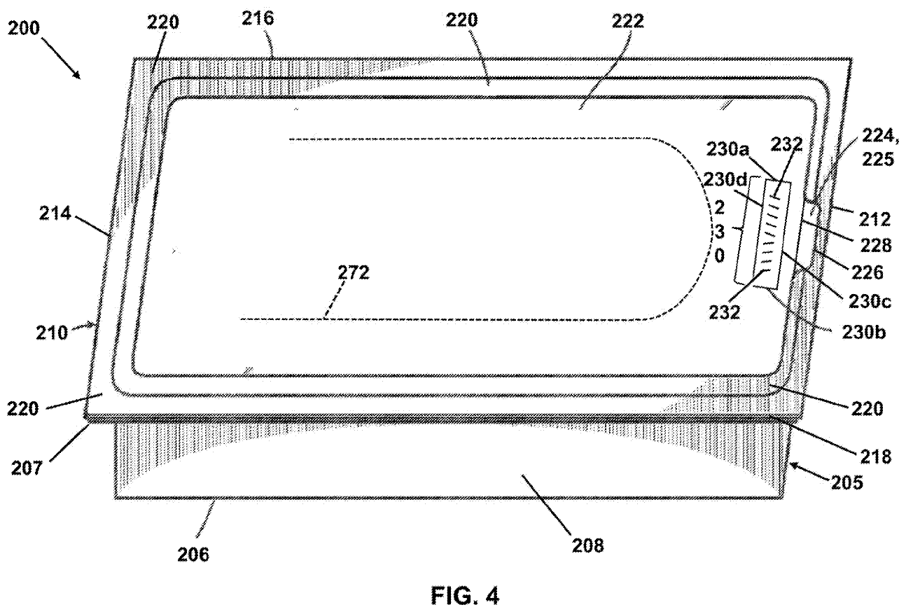

In various embodiments, the discontinuous series of shapes formed by the multiple lines of weakness within the frangible area may include any different number, size, orientation, etc. of shapes. The shapes within frangible area may be the same or different, may be repeating or non-repeating, may be linear shape, non-linear shape or both, etc. For example, as depicted in FIG. 1, the discontinuous series of shapes within the frangible area may comprise one non-linear shape that repeats; or, as depicted in FIG. 4, the discontinuous series of shapes within the frangible are may comprise a first linear shape that repeats and a second linear shape that repeats. In other embodiments, the discontinuous series may comprise a combination of linear shapes and non-linear shapes in various patterns, may comprise different non-linear shapes such that there is no repetition of shapes, may comprise two (or more) different non-linear shapes that repeat randomly or predictably, etc.

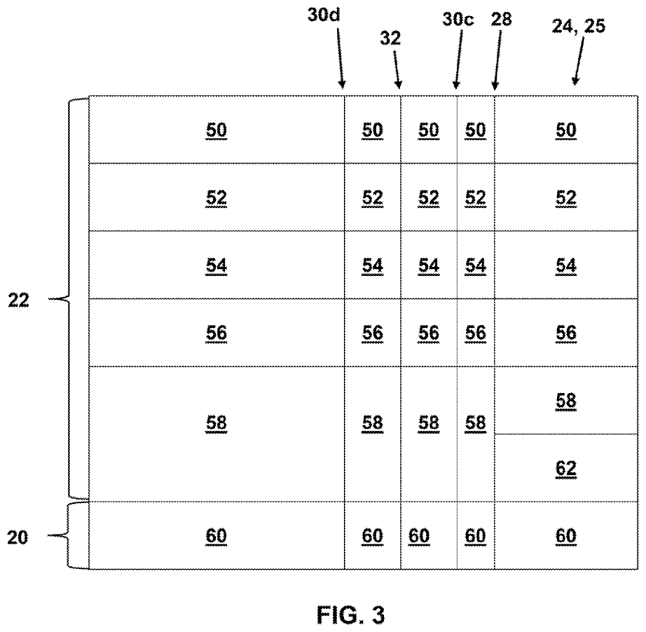

As described above, the finger-proof label may be a monolayer label or a multilayer label. FIG. 3 is a schematic cross-sectional view of the label of FIG. 1, taken along line 3-3. In the embodiments of FIGS. 1 and 3, the finger-proof label is a multilayer label comprising first layer 50, second layer 52, third layer 54, fourth layer 56, fifth layer 58, and sixth layer 60. Second ply 22 comprises first layer 50, second layer 52, third layer 54, fourth layer 56, fifth layer 58; and first ply 20 comprises sixth layer 60.

First layer 50 of second ply 22 may be an overlaminate layer or film or an abuse layer or film that withstands contact from other items or protects other layers of the label. In some embodiments, first layer 50 may comprise oriented polypropylene (OPP). In other embodiments, first layer 50 may comprise a multilayer film comprising OPP with a polyvinylidene chloride (PVdC) coating adjacent second layer 52.

Second layer 52 of second ply 22 may be an adhesive layer or tie layer securing first layer 50 to third layer 54 or fourth layer 56 or other layers of the label. In some embodiments, second layer 52 may comprise a UV adhesive.

Third layer 54 of second ply 22 may be an indicia layer and may comprise printing inks.

Fourth layer 56 of second ply 22 may be a label stock layer. The label stock layer may also be known as a carrier layer. In various embodiments, fourth layer 56 may comprise paper, nonwoven or woven material, latex material, plastic or thermoplastic material, foil, or other material as known to a person of ordinary skill in the packaging or label arts.

Fifth layer 58 of second ply 22 may be a removable adhesive layer. Removable adhesives are designed to form temporary bonds and can be removed after hours, days, months, or years. Some removable adhesives are designed to repeatedly separate and reattach. In this embodiment, the removable adhesive layer (i.e., fifth layer 58) of second ply 22 may be adapted to peelably reseal package label 10 to a package body (as further described below). A non-limiting example of a removable adhesive is a pressure sensitive adhesive, as described above. Non-limiting examples of pressure sensitive adhesives include but are not limited to those compositions that comprise a base elastomeric resin and a tackifier to enhance the ability of the adhesive to instantly bond and to enhance the bond strength. Examples of elastomers used as the base resin in tackified multicomponent pressure sensitive adhesives include but are not limited to natural rubber; polybutadiene; polyorganosiloxanes; styrene-butadiene rubber; carboxylated styrene-butadiene rubber, polyisobutylene; butyl rubber; halogenated butyl rubber; block polymers based on styrene with isoprene, butadiene, ethylene-propylene, or ethylene-butylene; or combinations of such elastomers. (See Yorkgitis, “Adhesive Compounds,” Encyclopedia of Polymer Science and Technology, Third Edition, 2003, Volume 1, pp. 256-290 (John Wiley & Sons, Inc., Hoboken, N.J.).)

In embodiments prior to application of the label to a package, film, or otherwise, sixth layer 60 (i.e., a layer of first ply 20) may be a release liner. In these embodiments, the release liner may be a paper, plastic, or thermoplastic carrier web material, any of which is coated on one or two sides with a release agent providing a release effect against the removable adhesive of fifth layer 58. The release agent may be solvent-based or water based and may be silicone, release varnish, release lacquer, or any other release agent.

In other embodiments, sixth layer 60 (i.e., a layer of first ply 20) may be a film layer. In these embodiments, the film layer may be thermoplastic and may be a monolayer film or a multilayer film. A non-limiting example of sixth layer 60 as a multilayer film is shown in Table 1.

TABLE 1

| Layer | Composition |
|---|---|
| Layer 1 | oriented polyethylene terephthalate (OPET) |
| Layer 2 | adhesive |
| Layer 3 | blend of low density polyethylene (LDPE) |
| | and linear low density polyethylene (LLDPE) |
| Layer 4 | anhydride-modified linear low density |
| | polyethylene (LLDPE) |
| Layer 5 | ethylene vinyl alcohol copolymer (EVOH) |
| | (e.g., with 38 mol % ethylene) |
| Layer 6 | anhydride-modified linear low density |
| | polyethylene (LLDPE) |
| Layer 7 | blend of low density polyethylene (LDPE) |
| | and linear low density polyethylene (LLDPE) |

As known to a person of ordinary skill in the packaging or label arts, the blend of LDPE and LLDPE in Layer 7 of this non-limiting example of sixth layer 60 may be considered a sealant layer. A sealant layer may be considered to be a layer of film involved in the sealing of the film to itself or to another layer of the same or another film, sheet, etc. As further described below, in some embodiments, the sealant layer of sixth layer 60 may seal package label 10 to a package body, such as, as a non-limiting example, a tray.

As depicted in FIG. 3, in the area of FIG. 1 along line 3-3, sixth layer 60 is coextensive with (i.e., having the same width as) the other layers of the label. However, as known to a person of ordinary skill in the packaging or label arts, in some embodiments such as those depicted in FIG. 1 (and FIG. 4 described below), sixth layer 60 (i.e., a layer of first ply 20) may not be generally coextensive with the other layers of package label 10. First ply 20 may have a width greater than the width of second ply 22 if package label 10 is used as a lidstock or lidding film for, as a non-limiting example, a tray. In such embodiments, sixth layer 60 (i.e. a layer of first ply 20) may have a width that is greater than the width of the other layers to provide a margin for sealing the label to the tray (for example, via a sealant layer of sixth layer 60).

As described above, package label 10 may be placed on or sealed to a package to facilitate access to contents of a package. To permit access, sixth layer 60, as an interior layer (i.e., a layer comprising the innermost surface of package label 10) adjacent the package, may include a second line of weakness (such as, second line of weakness 272 depicted in FIG. 4). Sixth layer 60 of first ply 20 may comprise the second line of weakness. As with the multiple lines of weakness forming the discontinuous series of shapes of the frangible area, the second line of weakness may comprise a continuous or discontinuous series of scores, holes, vents, slits, slots, perforations, notches, punctures, orifices, openings, inlets, channels, etc., in the surface of or through a layer or layers or the package label or may comprise a zone of an easy-tear material, such as an easy-tear sealant film, and the second line of weakness may be formed by die-cut, laser, or other means known to a person of ordinary skill in the packaging or label arts. The second line of weakness may be formed in various patterns to be consistent with patterns of permanent or removable (e.g., pressure sensitive) adhesive in a package label (including but not limited to in fifth layer 58 of second ply 22 or sixth layer 60 of first ply 22 of package label 10), as disclosed in, for example, U.S. Pat. No. 7,681,732 (Moehenbrock et al.), U.S. Pat. No. 6,589,622 (Scott), U.S. Pat. No. 7,717,620 (Hebert et al.), or PCT International Publication Number 2015/002651 (Curwood, Inc.).

As depicted in FIG. 3, package label 10 also includes first section 62. First section 62 is designed to facilitate “deadening” of adhesive deadener area 25 and grasping of pull tab 24. First section 62 facilitates “deadening” of pull tab 24 and the ability of an end-user to grasp pull tab 24 to open a package to which package label 10 is applied. First section 62 may comprise release agent (e.g., as described above), a removable adhesive with lower bond strength than the removable adhesive of fifth layer 58, no material (e.g., a “blank” area), or other materials. If the removable adhesive of fifth layer 58 is “flood coated,” i.e., applied to the entirety of second ply 22 of package label 10, first section 62 may be positioned above or below (as depicted in FIG. 3) fifth layer 58, depending on the desired location of removable adhesive (as known to a person of ordinary skill in the packaging or label arts). If the removable adhesive of fifth layer 58 is “pattern applied.” i.e., applied to less than the entirety of second ply 22 of package label 10, first section 62 may be adjacent but not above or below the removable adhesive of fifth layer 58 (not depicted).

FIG. 4 is a partial perspective view of a package with an embodiment of a finger-proof package label according to the present application. Package 200 comprises package body 205 and package label 210.

In the embodiment of FIG. 4, package body 205 is exemplified as (as a non-limiting example) a tray. Package body 205 as a tray comprises bottom portion 206, top portion 207, and side portion 208 connecting bottom portion 206 to top portion 207. In some embodiments, top portion 207 may comprise a perimeter flange to facilitate sealing of package label 210 to package body 205.

Package label 210 comprises first edge 212, second edge 214 opposing first edge 212, third edge 216 substantially perpendicular to first edge 212 and second edge 214, and fourth edge 218 opposing third edge 216. Package label 210 further comprises first ply 220 and second ply 222. Each of first ply 220 and second ply 222 may comprise a monolayer film or a multilayer film.

Second ply 222 comprises pull tab 224. Pull tab 224 comprises first boundary 226, second boundary 228 opposing first boundary 226, and, as pull tab 224 is unsealed (completely or partially), adhesive deadener area 225 facilitating grasping of pull tab 224. Adhesive deadener area 225 may be positioned at any location on or throughout the interior surface (i.e., the innermost surface) of pull tab 224. In the embodiment of FIG. 4, adhesive deadener area 225 is positioned throughout the interior surface of pull tab 224.

First boundary 226 of pull tab 224 is adjacent first edge 212. In some embodiments, such as that depicted in FIG. 4, first boundary 226 may be directly adjacent (i.e., in direct contact) with first edge 212. As above, in other embodiments, the first boundary may be spaced apart from but still adjacent (i.e., in the proximity of, near, close, or neighboring in proximity to) the first edge.

In some embodiments, such as that depicted in FIG. 4, first boundary 226 of pull tab 224 is positioned at an approximate center of first edge 212. In other embodiments, the first boundary and the pull tab are not limited to a centered position and may be positioned at any location adjacent the first edge.

Second ply 222 also comprises frangible area 230. In some embodiments, such as that depicted in FIG. 4, frangible area 230 is adjacent second boundary 228, specifically, parallel to each of first boundary 226 and second boundary 228. In other embodiments, such as those where the first boundary is non-linear and the second boundary is linear, the frangible area may be adjacent the second boundary and parallel to the second boundary but not the first boundary. In yet other embodiments where each of the first boundary and the second boundary is non-linear, the frangible area may be adjacent the second boundary but not parallel to either the first boundary or the second boundary. Frangible area 230 is positioned apart from, i.e., separated from and not in the region of, pull tab 224, specifically (in the embodiment depicted in FIG. 4) adhesive deadener area 225 of pull tab 224.

Frangible area 230 comprises first end 230a, second end 230b opposing first end 230a, first side 230c substantially perpendicular to first end 230a and second end 230b, and second side 230d opposing first side 230c. Frangible area 230 also comprises multiple lines of weakness forming discontinuous series of shapes 232. In the embodiment depicted in FIG. 4, discontinuous series of shapes 232 comprises a first linear shape that repeats and a second linear shape that repeats, i.e., a first set of angled line segments and a second set of angled line segments. In other embodiments, the discontinuous series of shapes may be any of that depicted in FIG. 2 or otherwise described above.

In some embodiments, as in the embodiment depicted in FIG. 4, no linear line of weakness is present that connects the discontinuous series of shapes, e.g., no linear “first” line of weakness (whether continuous or discontinuous) connects angled line segments within discontinuous series of shapes 232 from first end 230a to second end 230b. In this embodiment, the angled line segments are discontinuous and unconnected within frangible area 230.

As depicted in the embodiment of FIG. 4, first ply 220 is not coextensive with second ply 222 but has a width that is greater than the width of second ply 222. This, in part, facilitates sealing of package label 210 to package body 205. First ply 220 comprises a sealant layer to seal package label 210 to top portion 207 (e.g., a perimeter flange) of package body (e.g., tray) 205.

First ply 220 also includes second line of weakness 272. As described above, second line of weakness 272 facilitates access to contents of package 200 when package label 210 is peeled from package body 205. When package label 210 is peeled (but not necessarily fully removed) from package body 205, layers of package label 210 separate at second line of weakness 272 to provide an opening to access contents of package 200. If second ply 222 of package label 210 comprises a removable adhesive layer, package label 210 may be peelably resealed to package body 205 once an end-user removes the desired contents from package 200.

Each and every document cited in this present application, including any cross-referenced or related patent or application, is incorporated in this present application in its entirety by this reference, unless expressly excluded or otherwise limited. The citation of any document is not an admission that it is prior art with respect to any embodiment disclosed or claimed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application (including the appended claims) governs.

Unless otherwise indicated, all numbers expressing sizes, amounts, ranges, limits, and physical and other properties used in the present application (including the appended claims) are to be understood as being preceded in all instances by the term “about”. Accordingly, unless expressly indicated to the contrary, the numerical parameters set forth in the present application (including the appended claims) are approximations that can vary depending on the desired properties sought to be obtained by a person of ordinary skill in the packaging or label arts without undue experimentation using the teachings disclosed in the present application.

As used in the present application (including the appended claims), the singular forms “a,” “an,” and “the” encompass embodiments having plural referents, unless the context clearly dictates otherwise. As used in the present application (including the appended claims), the term “or” is generally employed in its sense including “and/or,” unless the context clearly dictates otherwise.

Spatially related terms, including but not limited to, “lower,” “upper,” “beneath,” “below,” “above,” “bottom,” and“op,” if used in the present application (including the appending claims), are used for ease of description to describe spatial relationships of element(s) to another. Such spatially related terms encompass different orientations of the package in use or operation, in addition to the particular orientations depicted in the drawings and described in the present application (including the appended claims). For example, if an object depicted in the drawings is turned over or flipped over or inverted, elements previously described as below or beneath other elements would then be above those other elements.

The description, examples, embodiments, and drawings disclosed are illustrative only and should not be interpreted as limiting. The present invention includes the description, examples, embodiments, and drawings disclosed; but it is not limited to such description, examples, embodiments, or drawings. The reader should assume that features of one disclosed embodiment may also be applied to all other disclosed embodiments, unless expressly indicated to the contrary. Modifications and other embodiments will be apparent to a person of ordinary skill in the packaging or label arts, and all such modifications and other embodiments are intended and deemed to be within the scope of the present invention as described in the claims. What is claimed is as follows:

1. A package label comprising a first ply, a second ply, and a first edge, wherein the second ply comprises
a pull tab comprising a first boundary adjacent the first edge, a second boundary opposing the first boundary, and an adhesive deadener area, and
a frangible area adjacent the second boundary and positioned apart from the adhesive deadener area, wherein the frangible area comprises multiple lines of weakness forming a discontinuous series of shapes.

2. The package label of claim 1 wherein the discontinuous series of shapes is formed in the absence of a linear first line of weakness that connects the discontinuous series of shapes from a first end of the frangible area to a second end of the frangible area.

3. The package label of claim 1 wherein the package label is adapted to prevent an object from being inserted underneath the pull tab to access contents of a package body.

4. The package label of claim 1 wherein the package label is adapted to tear at the frangible area when an object is inserted underneath the pull tab.

5. The package label of claim 1 wherein the discontinuous series of shapes comprises a series of linear shapes.

6. The package label of claim 5 wherein a first half of the linear shapes forms a 30° angle with the second boundary and a second half of the linear shapes forms a 150° angle with the second boundary.

7. The package label of claim 1 wherein the discontinuous series of shapes comprises a series of non-linear shapes.

8. The package label of claim 1 wherein each of the shapes within the discontinuous series of shapes has an open geometry shape.

9. The package label of claim 1 wherein the discontinuous series of shapes comprises a combination of linear shapes and non-linear shapes.

10. The package label of claim 1 wherein the first boundary of the pull tab is positioned at an approximate center of the first edge.

11. The package label of claim 1 wherein the first ply comprises a second line of weakness.

12. The package label of claim 1 wherein the first ply comprises a sealant layer adapted to seal the package label to a package body.

13. The package label of claim 1 wherein each of the first ply and the second ply comprises multiple layers.

14. The package label of claim 13 wherein the second ply comprises a removable adhesive layer adapted to peelably reseal the package label to a package body.

15. A package comprising the package label of claim 1 wherein the package label is sealed to a package body.

16. The package of claim 15 wherein the package body is a tray.
